(19) United States
(12) Patent Application Publication
(10) Pub. No.: US 2010/0148128 A1
(43) Pub. Date: Jun. 17, 2010

(54) Pad printing of cathode active materials for incorporation into electrochemical cells

(76) Inventors: Ashish Shah, East Amherst, NY (US); Keith Seitz, Niagara Falls, NY (US)

Correspondence Address: Greatbatch Ltd., 10,000 Wehrle Drive, Clarence, NY, 14031, US

(21) Appl. No.: 11/037,875

(22) Filed: Jan. 18, 2005

(51) Int. Cl. H01B 1/24

(52) U.S. Cl. 252/507; 252/500; 252/509; 252/508

(57) ABSTRACT

Deposition of an electrode active material printing suspension onto a conductive substrate by various pad-printing techniques is described. After heat-treating to evaporate the solvent and decompose a printing binder, an electrode active coating suitable for incorporation into an electrochemical cell is provided.

### BACKGROUND OF THE INVENTION

1. Field of the Invention

The present invention generally relates to the conversion of chemical energy into electrical energy. More particularly, the present invention relates to pad printing processes for coating an electrode active suspension on a conductive current collector substrate. Preferably, the suspension is of an electrode active material, such as of silver vanadium oxide, for an electrochemical cell. The silver vanadium oxide is provided as a printable ink comprising an aqueous or non-aqueous carrier and a printing binder.

2. Prior Art

An implantable cardiac defibrillator is a device that requires a power source for a generally medium rate, constant resistance load component provided by circuits performing such functions as, for example, the heart sensing and pacing functions. From time-to-time, the cardiac defibrillator may require a generally high rate, pulse discharge load component that occurs, for example, during charging of a capacitor in the defibrillator for the purpose of delivering an electrical shock to the heart to treat tachyarrhythmias, the irregular, rapid heartbeats that can be fatal if left uncorrected.

It is generally recognized that lithium cells containing silver vanadium oxide (SVO) and, in particular, ε-phase silver vanadium oxide (AgV₂O_{5.5}), are preferred for powering cardiac defibrillators. Silver vanadium oxide is preferred because it delivers high current pulses or high energy within a short period of time. However, it is believed that the discharge performance of this cell chemistry is further improved by contacting the high rate SVO material to the current collector in the form of printable ink. The ink promotes adhesion by more readily coating irregularities of the current collector including flowing into its openings to completely lock to the active material coated onto the opposite side thereof. This is regardless whether the active material mixtures on the opposite side of the current collector are of the same chemistry or different, for example SVO and CFₓ in an electrode configuration SVO/current collector/CFₓ. Coating an active ink suspension onto a conductive substrate using a pad printing technique does this.

### SUMMARY OF THE INVENTION

Accordingly, the present invention describes the deposition of a metal-containing suspension onto a conductive current collector substrate by various pad-printing techniques. This results in consistent location of an electrode active coating on the current collector, especially when only a portion of the substrate is to be coated with other portions left uncoated. Other advantages include coating thickness uniformity and better adhesion.

In a pad-printing process, the printing ink contains the cathode active material and a printing binder well dispersed in a stable suspension comprising an aqueous or non-aqueous carrier. The ink is printed onto a conductive substrate serving as a current collector that is then heated to evaporate the solvent and decompose or otherwise at least partially remove the printing binder. The printing binder is a viscosity modifier that aids in processing the printing ink and in the pad printing process. Upon heating to evaporate the solvent, the printing binder burns off. However, it is not critical that the binder is completely decomposed, as residual carbon can serve as a conductivity enhancer or augment the conductive material that is typically added to the cathode active mixture.

These and other objects of the present invention will become increasingly more apparent to those skilled in the art by a reading of the following detailed description in conjunction with the appended drawings.

### BRIEF DESCRIPTION OF THE DRAWINGS

FIG. 1 is a schematic view of a first embodiment of a sealed ink cup pad printing apparatus 10 of the present invention showing a printing tampon 12, current collector 16, cliché 46 and ink cup 54 prior to the start of a cycle.

FIG. 1A is a perspective view of the printing tampon 12.

FIG. 2 is a schematic view of the pad printing apparatus 10 with printing ink 14 filled in the recess 52 of the cliché and the printing tampon contacting the ink.

FIG. 3 is a schematic view of the pad printing apparatus 10 with the inked printing tampon positioned vertically above the current collector 16.

FIG. 4 is a schematic view of the pad printing apparatus 10 with the inked printing tampon contacting the current collector.

FIG. 5 is a schematic view of the pad printing apparatus 10 before the inked current collector is moved to a further processing step.

FIG. 6 is a perspective view of the inked current collector.

FIG. 6A is a cross-sectional view along line 6A-6A of FIG. 6

FIG. 6B is a cross-sectional view similar to that shown in FIG. 6A, but of active materials contacted to the current collector in a conventional manner.

FIG. 7 is a schematic view of a second embodiment of a sealed ink cup pad printing apparatus 100 of the present invention showing the printing tampon 12 positioned vertically above the current collector 16 and with an ink cup 54 filling the printing ink into the recess 102 of a cliché 104 prior to the start of a cycle.

FIG. 8 is a schematic view of the pad printing apparatus 100 with printing ink 14 filled in the recess of the cliché and the printing tampon positioned vertically above the ink.

FIG. 9 is a schematic view of the pad printing apparatus 100 with the printing tampon picking up the ink in the cliché recess.

FIG. 10 is a schematic view of the pad printing apparatus 100 with the inked printing tampon positioned vertically above the current collector.

FIG. 11 is a schematic view of the pad printing apparatus 100 with the inked printing tampon contacting the current collector.

FIG. 12 is a schematic view of the pad printing apparatus 100 before the inked current collector is moved to a further processing step.

FIG. 13 is a schematic view of a third embodiment of a sealed ink cup pad printing apparatus 110 of the present invention showing the printing tampon 12 positioned vertically above the recess 118 of a cliché 116 prior to the start of a cycle.

FIG. 14 is a schematic view of the pad printing apparatus 110 with printing ink 14 filled in the cliché recess and the printing tampon positioned vertically above the ink.

FIG. 15 is a schematic view of the pad printing apparatus 110 with the printing tampon picking up the ink in the cliché recess.

FIG. 16 is a schematic view of the pad printing apparatus 110 with the inked printing tampon positioned vertically above the current collector.

FIG. 17 is a schematic view of the pad printing apparatus 110 with the inked printing tampon contacting the current collector.

FIG. 18 is a schematic view of the pad printing apparatus 110 before the inked current collector is moved to a further processing step.

FIG. 19 is a schematic view of an open inkwell pad printing apparatus 200 of the present invention showing a printing tampon 12, current collector 16, cliché 202 and ink well 206 prior to the start of a cycle.

FIG. 20 is a schematic view of the pad printing apparatus 200 with printing ink 14 filled in the recess 204 of the cliché 202 by a squeegee with excess ink being removed by a doctor blade 212.

FIG. 21 is a schematic view of the pad printing apparatus 200 with the printing tampon 12 contacting the ink.

FIG. 22 is a schematic view of the pad printing apparatus 200 with the inked printing tampon 12 positioned vertically above the current collector 16.

FIG. 23 is a schematic view of the pad printing apparatus 200 with the inked printing tampon 12 contacting the current collector 16.

FIG. 24 is a schematic view of a rotary gravure pad printing apparatus 300 showing a cliché drum 304 picking up a printing ink 14 from a well 302 for transfer to a main roller 306 and ultimately to current collectors located on a substrate wheel 308.

FIG. 25 is a schematic view of the rotary gravure pad printing apparatus 300 with the printing ink 14 being transferred from the cliché drum 304 to the main roller 306.

FIG. 26 is a schematic view of the rotary gravure pad printing apparatus 300 with the printing ink 14 contacted to the main roller 306.

FIG. 27 is a schematic view of the rotary gravure pad printing apparatus 300 with the printing ink 14 being transferred from the main roller 306 to current collectors located on a substrate wheel 308.

### DETAILED DESCRIPTION OF THE PREFERRED EMBODIMENTS

The present invention will be described with respect to various pad-printing techniques for depositing or coating an electrode active material suspension onto a conductive current collector substrate. The pad printing techniques include those performed by sealed ink cup pad printing, open inkwell pad printing and rotary gravure pad printing.

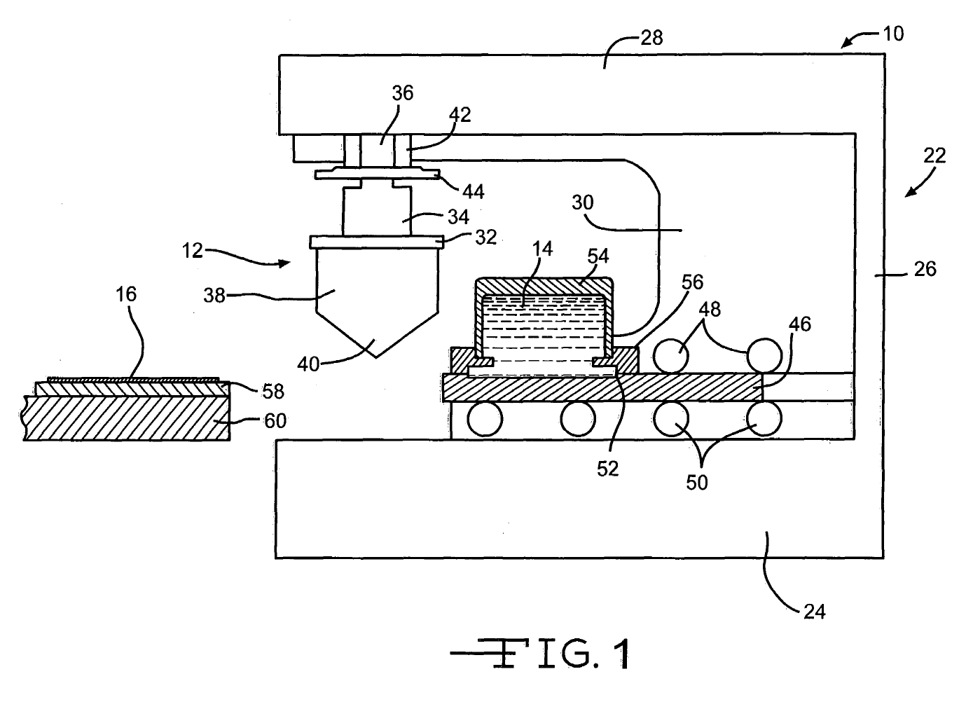

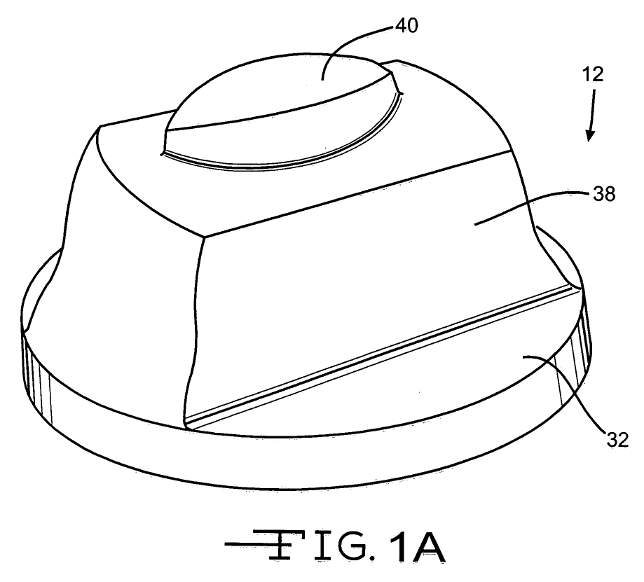

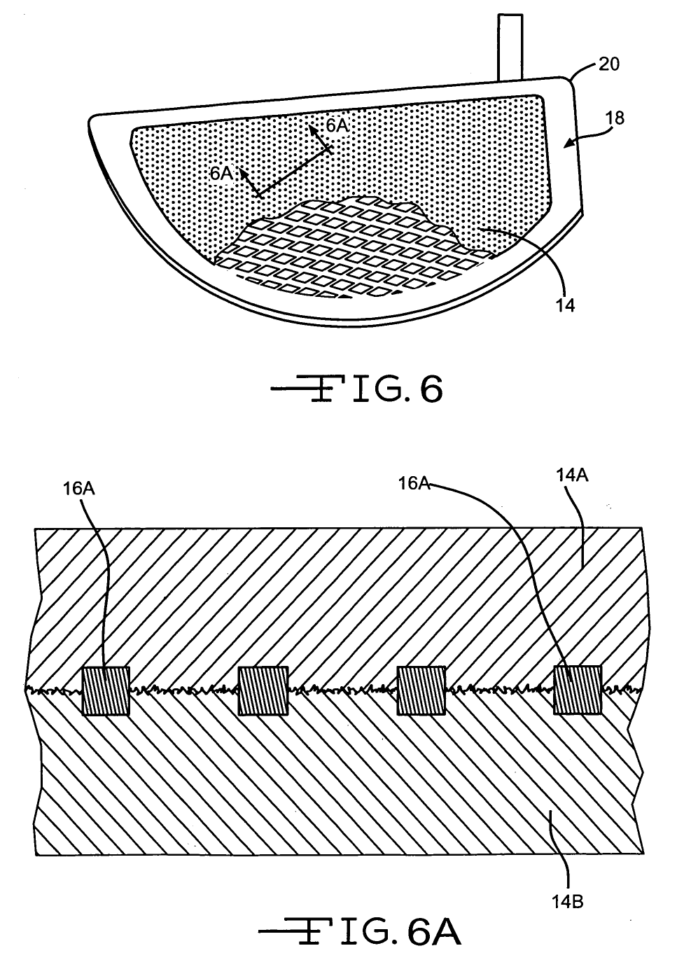

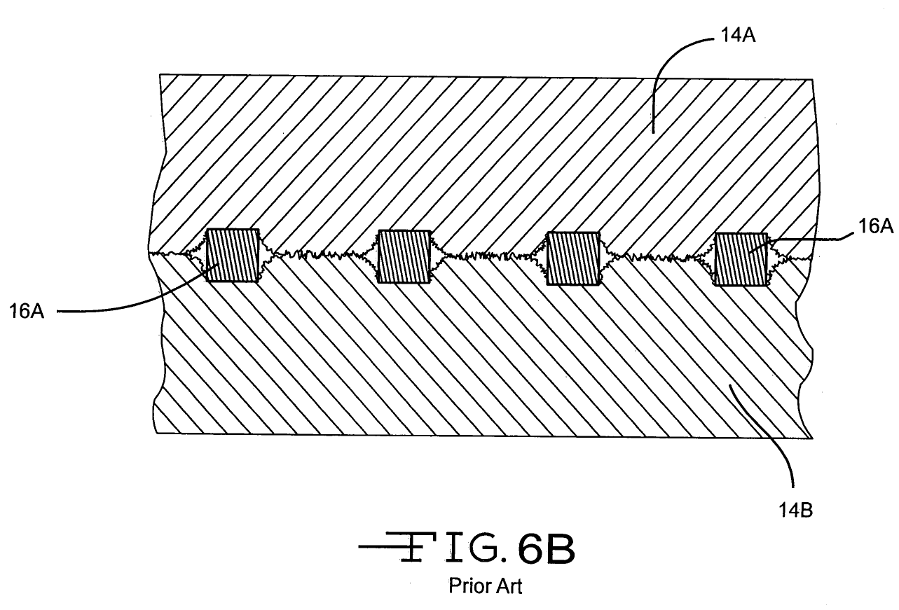

Turning now to the drawings, FIGS. 1 to 5 illustrate a first embodiment of a sealed ink cup pad printing apparatus 10 using a printing tampon 12 (FIG. 1A) for precisely and evenly contacting an ink 14 of an electrode active material suspension to a substrate. The substrate can be planar or non-planar as a non-perforated or perforated current collector 16 (FIG. 6) or a shaped member as a casing portion. For the cathode of a primary electrochemical cell, the printing ink includes a solid active material suspended in an aqueous or non-aqueous carrier along with a printing binder, a conductive diluent and, if desired, an electrode binder. The cathode active material comprises a metal element, a metal oxide, a mixed metal oxide or a metal sulfide, and combinations thereof. A particularly preferred active material is of a nanoparticle sized metal vanadium oxide.

Preferred preparation techniques for metal vanadium oxide nanoparticles comprise reacting a silver-containing compound and a vanadium-containing compound. For example, if silver vanadium oxide is the desired product, suitable silver starting materials include Ag, AgNO₃, AgNO₂, Ag₂O₂, AgVO₃, Ag₂CO₃, Ag(CH₃CO₂), and mixtures thereof, while the vanadium-containing compound is selected from NH₄VO₃, AgVO₃, VO, VO_{1.27}, VO₂, V₂O₄, V₂O₃, V₃O₅, V₄O₉, V₆O₁₃, V₂O₅, and mixtures thereof.

Suitable preparation techniques are more thoroughly discussed in U.S. application Ser. No. 10/391,885, filed Mar. 19, 2003. They include sol-gel synthesis (U.S. Pat. No. 5,555,680 to Takeuchi et al.), hydrothermal synthesis (U.S. application Ser. No. 10/894,305, filed Jul. 19, 2004), combustion chemical vapor deposition (CCVD) (U.S. Pat. No. 5,652,021 to Hunt et al.), spray pyrolysis, laser pyrolysis (U.S. Pat. No. 6,225,007 to Horne et al.), combination reaction (U.S. Pat. No. 5,221,453 to Crespi et al.), decomposition synthesis (U.S. Pat. Nos. 4,310,609 and 4,391,729, both to Liang et al.), an amorphous SVO reaction (U.S. Pat. No. 5,498,494 to Takeuchi et al.), and a heat-treated SVO reaction (U.S. Pat. No. 5,955,218 to Crespi et al.). The above patents and applications are incorporated herein by reference.

One preferred metal vanadium oxide has the general formula SMₓV₂O_{y} where SM is a metal selected from Groups IB to VIIB and VIII of the Periodic Table of Elements, wherein x is about 0.30 to 2.0 and y is about 4.5 to 6.0 in the general formula. By way of illustration, and in no way intended to be limiting, one exemplary metal vanadium oxide comprises silver vanadium oxide having the general formula AgₓV₂O_{y} in any one of its many phases, i.e., β-phase silver vanadium oxide having in the general formula x=0.35 and y=5.8, γ-phase silver vanadium oxide having in the general formula x=0.74 and y=5.37 and ε-phase silver vanadium oxide having in the general formula x=1.0 and y=5.5, and combination and mixtures of phases thereof. For a more detailed description of such cathode active materials reference is made to the previously discussed U.S. Pat. No. 4,310,609 to Liang et al. Another preferred metal vanadium oxide cathode material includes V₂O_{z} wherein z≦5 combined with Ag₂O with silver in either the silver(II), silver(I) or silver(0) oxidation state and CuO with copper in either the copper(II), copper(I) or copper(0) oxidation state to provide the mixed metal oxide having the general formula CuₓAg_{y}V₂O_{z}, (CSVO) with 0.01≦z≦6.5. Typical forms of CSVO are Cu_{0.16}Ag_{0.67}V₂O_{z} with z being about 5.5 and Cu_{0.5}Ag_{0.5}V₂O_{z} with z being about 5.75. The oxygen content is designated by z since the exact stoichiometric proportion of oxygen in CSVO can vary depending on whether the cathode material is prepared in an oxidizing atmosphere such as air or oxygen, or in an inert atmosphere such as argon, nitrogen and helium. For a more detailed description of this cathode active material reference is made to U.S. Pat. Nos. 5,472,810 to Takeuchi et al. and 5,516,340 to Takeuchi et al., both of which are assigned to the assignee of the present invention and incorporated herein by reference.

Metal vanadium oxide particles produced by the above-referenced techniques have an average particle size of less than about 500μ and, more preferably, an average diameter of from about 0.5μ to about 200μ for suspension in ink suitable for use with a pad printing process. Preferably, the active particles have a very narrow distribution of particle diameters without a tail. In other words, there are effectively no particles with a diameter an order of magnitude greater than the average diameter such that the particle size distribution rapidly drops to zero.

Suitable solvents include cyclohexanone (b.p.=155.6° C.), n-octyl alcohol (b.p.=171° C.), ethylene glycol (b.p.=197° C.), and water. These liquids do not readily evaporate at room temperature and maintain rheology or viscosity during printing. The printing ink 14 is preferably at a concentration of from about 150 to about 500 grams of the cathode active material per liter.

The printing ink 14 further includes a printing binder. Suitable printing binders include ethyl cellulose, acrylic resin, polyvinyl alcohol, polyvinyl butyral and a poly(alkylene carbonate) having the general formula R—O—C(═O)—O with R═C1 to C5. Poly(ethylene carbonate) and poly(propylene carbonate) are preferred as they burn out in virtually any atmosphere including nitrogen, air, hydrogen, argon and vacuum. Suitable poly(alkylene carbonate) binders are commercially available from Empower Materials, Inc., Newark, Del. under the designations QPAC 25 and QPAC 40.

If desired, the printing ink is further provided with an electrode binder comprising a powdered fluoro-polymer. The electrode binder is different than the printing binder, and does not decompose when subjected to the temperatures used to drive off or at least partially decompose the printing binder. Instead, it remains in the electrode active mixture to add structural integrity to the subsequently formed electrode so that the electrode active material does not crack, slough off or otherwise lose contact with the current collector during subsequent manufacturing steps and during cell discharge. More preferably, the fluoro-polymer electrode binder is powdered polytetrafluoroethylene or powdered polyvinylidene flouride present at about 1 to about 5 weight percent of the cathode mixture.

Further, up to about 10 weight percent of a conductive diluent is preferably added to the ink to improve conductivity of the product electrode active mixture. Suitable materials for this purpose include acetylene black, carbon black and/or graphite or a metallic powder such as powdered nickel, aluminum, titanium and stainless steel. The preferred cathode active mixture thus includes a powdered fluoro-polymer binder present at about 3 weight percent, a conductive diluent present at about 3 weight percent and about 94 weight percent of the metal vanadium oxide active material.

The current collector 16 preferably consists of a conductive metal such as titanium, molybdenum, tantalum, niobium, cobalt, nickel, stainless steel, tungsten, platinum, palladium, gold, silver, copper, chromium, vanadium, aluminum, zirconium, hafnium, zinc, iron, and mixtures and alloys thereof, and comprises a major face serving as a contact surface 18 surrounded by a peripheral edge 20 (FIG. 6). The printing tampon 12 deposits the printing ink 14 onto of the current collector 16 in a specifically designed pattern dictated by the electrode (not shown) to be constructed. In general, the thickness of the current collector 16 is in the range of about 0.001 millimeters to about 2 millimeter, and preferably about 0.05 millimeters.

Regardless of the material of the current collector 16, coating integrity relies mostly upon mechanical bonding to the contacted surface 18. It is, therefore, critical that the current collector 16 is properly prepared to ensure coating quality. For one, substrate surface cleanliness is very important in all coating systems. In that respect, it is required that the substrate 16 remain uncontaminated by lubricants from handling equipment or body oils from hands, and the like. Current collector cleaning includes chemical means such as conventional degreasing treatments using aqueous and non-aqueous solutions, as are well known to those skilled in the art. Plasma cleaning is also used.

After current collector surface cleaning, surface roughness is the next most critical factor for coating adhesion. The contact surface 18 may be roughened by chemical means, for example, by contacting the current collector with hydrofluoric acid and/or hydrochloric acid containing ammonium bromide and methanol, and the like, by plasma etching, and by mechanical means such as scraping, machining, wire brushing, rough threading, grit blasting, a combination of rough threading then grit blasting and abrading such as by contacting the current collector with Scotch-Brite® abrasive sheets manufactured by 3M.

If desired, the electrical conductivity of the current collector 16 is improved prior to coating. Metal and metal alloys naturally have a native oxide on their exposed surfaces. This is a resistive layer and hence, if the material is to be used as a substrate for a cell electrode, the oxide is preferably removed or made electrically conductive prior to deposition of an active coating thereon. In order to improve the electrical conductivity of the current collector 16, various techniques can be employed. One is shown and described in U.S. Pat. No. 6,740,420 to Muffoletto et al., which is assigned to the assignee of the present invention and incorporated herein by reference.

Returning to FIGS. 1 to 5, the sealed ink cup pad printing apparatus 10 comprises a main frame 22 having a platform 24 to which is fixed a vertical support beam 26 and a cantilevered arm 28. A generally C-shaped plate 30 is secured to the platform, vertical beam and cantilevered arm to add support to the main frame. The printing tampon 12 depends from the cantilevered arm 28 for actuation in a relative upwardly and downwardly vertical direction towards and away from the arm.

The printing tampon 12 comprises a backing plate 32 detachably secured to a piston 34 at the distal end of a piston rod 36. The printing tampon 12 is more clearly shown in FIG. 1A comprising the backing plate 32 supporting a polymeric main body 38 provided with an extending pad portion 40. The pad portion 40 is shown as a curved surface, but when it is deformed by contact with the current collector 16, it assumes the desired peripheral shape.

The piston rod 36 resides in a closely spaced relationship in a cylinder 42 that precisely controls the axis of vertical movement of the piston 34 and attached printing tampon 12. A limit plate 44 is secured to the piston rod 36 adjacent to the piston 34. This ensures that the piston does not retract upwardly too far to be damaged by a collision with the C-shaped plate 30 and cantilevered arm.

The mainframe platform 24 supports a cliché 46 that actuates in a back and forth manner on a series of upper and lower bearings 48 and 50, respectively. The cliché 46 is a plate shaped metal member, such as of A2 tool steel coated with a diamond like carbon finish. The cliché has a chemically etched recess 52 sized to create the image or perimeter of the printing ink 14 to be deposited on the current collector 16. A cup 54 containing the printing ink 14 is supported on the cliché 46 by a magnetic sealing ring 56. The magnetic attraction between the cliché and ring provides a closely spaced tolerance that squeegees the printing ink 14 filled into the recess 52 to a precise depth. The printing ink 14 is now ready for subsequent transfer to the printing tampon 12 as the cliché 46 travels back and forth. This will be described in greater detail hereinafter.

As shown in FIG. 1, the sealed ink cup printing process according to this first embodiment of the present invention begins with the current collector 16 resting on a block 58 that may be thermally conductive, which in turn is supported on a work stage 60. The work stage 60 is preferably temperature controlled and provides for movement of the block 58. In that manner, the block conducts heat to the current collector 16 to maintain it at a temperature sufficient to solidify the active material by evaporating the solvent and at least partially combusting the binder.

As shown in the drawing of FIG. 1, a pad printing cycle of the first embodiment begins with the cliché 46 in a retracted position having its recess 52 directly aligned with the ink cup 54 magnetically sealed thereto by the ring 56.

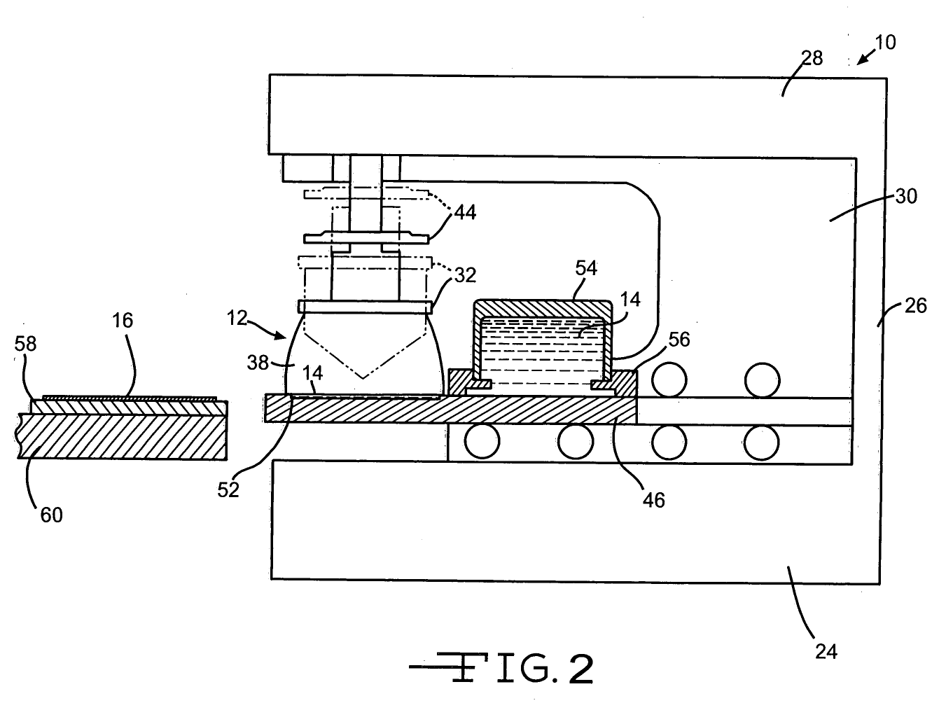

In FIG. 2, the cliché has moved to the left such that the printing ink 14 filled in the recess 52 is completely free of the ink cup 54 and in a precise vertical alignment with the retracted printing tampon 12. The piston 34 is then actuated to move the printing tampon 12 in a downwardly direction to have the extended pad portion 40 contact and pick up the ink 14 onto its printing surface. As previously discussed, the extending pad portion 40 has a curved surface that helps prevent splashing the ink 14 as the printing tampon 12 is moved into contact with the cliché. In that respect, downward actuation of the printing tampon 12 continues until the pad portion 40 has deformed into the recess 52 to pick up the printing ink 14 deposited therein.

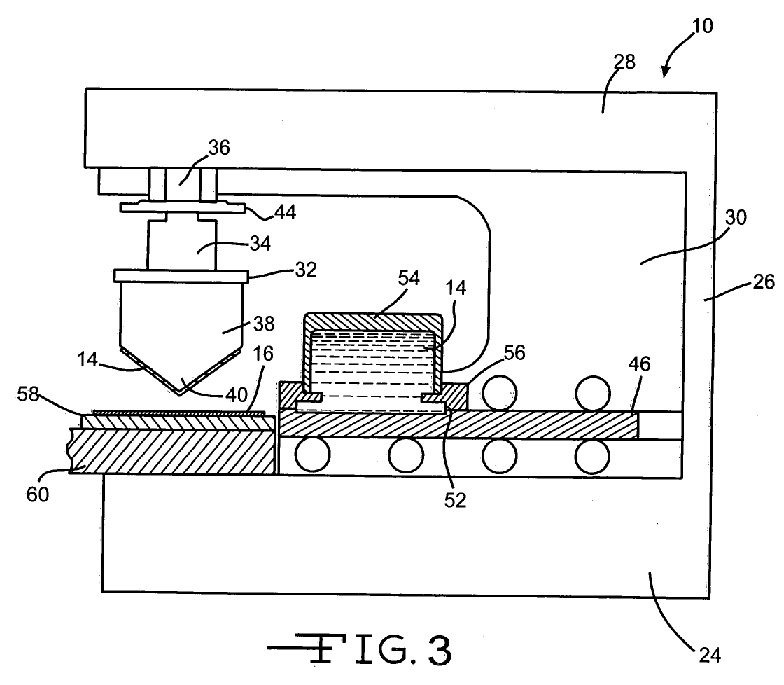

As shown in FIG. 3, the inked printing tampon 12 then retracts into a raised position as the cliché 46 is simultaneously retracted away from vertical alignment with the current collector 16. The recess 52 of the cliché 46 is once again aligned with the ink cup 54 for filling another charge of printing ink therein. As this occurs, the work stage 60 is simultaneously actuated to move into a position with the conductive block 58 supporting the current collector 16 directly aligned beneath the inked printing tampon 12.

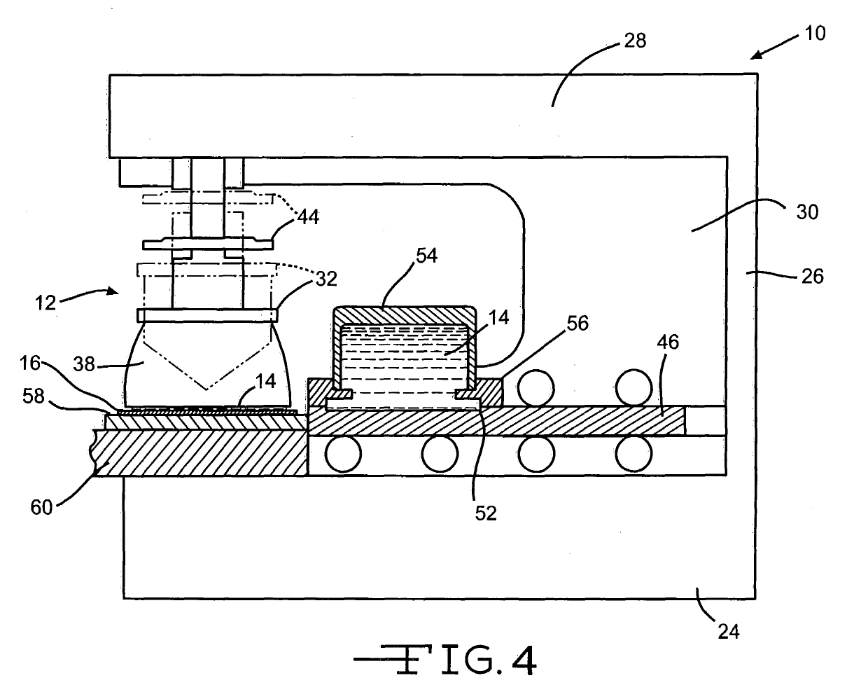

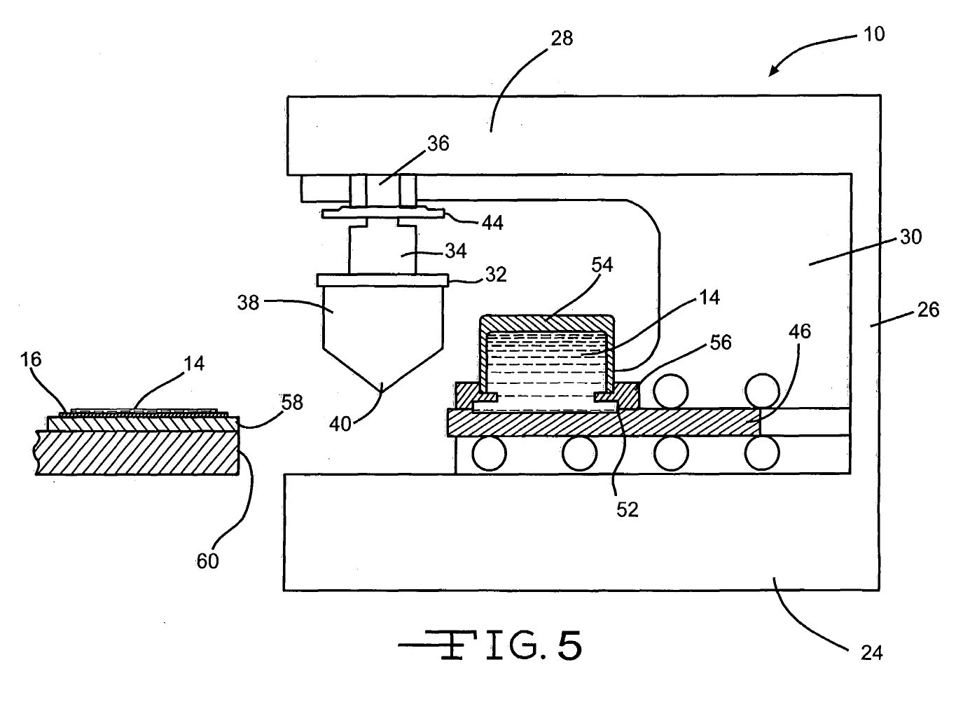

In FIG. 4, the printing tampon 12 is actuated in a downwardly direction to contact the major face 18 of the current collector 16 with its inked pad portion 40. As this occurs, the pad portion 40 deforms to completely contact the area of the current collector major face 18 to be coated with the printing ink. The surface tension of the printing ink on the contact surface 18 is greater than the surface tension of the ink contacting the pad portion 40 of the printing tampon. In that manner, the printing ink 14 is deposited onto the contact surface 18 of the current collector when the printing tampon 12 moves into the retracted position of FIG. 5. The work stage 60 also retracts into its starting position.

During deposition of the printing ink 14 onto the current collector 16, the conductive block 58 and work stage 60 maintain the substrate at a temperature sufficient to evaporate or otherwise drive off the solvent from the deposited printing mixture. Thus, as the current collector 16 is being coated with the printing ink, the contact surface 18 is at a temperature sufficient to begin driving off or otherwise evaporating the solvent material. Preferably, the solvent is evaporated from the current collector 16 almost instantaneously with contact by the printing ink 14 resulting in deposition of a relatively thin film coating of the cathode active mixture. Heating the current collector to a first temperature of at least about 100° C. does this. In addition, printing can be done at ambient temperature with solvent removal performed in a subsequent process.

After deposition and solvent removal, the cathode active material coated current collector is heated to a second temperature of up to about 200° C. for at least about five minutes to about three hours. This heating protocol is sufficient to remove any residual solvent and at least partially burn off the printing binder from the cathode active coating. In another embodiment, the current collector 16 is maintained at a temperature sufficient to, for all intents and purposes, instantaneously evaporate the solvent and at least partially decompose the printing binder. A heating temperature for the current collector of up to about 200° C. is preferred for this. The decomposition temperature is about 220° C. for the previously described poly(ethylene carbonate) printing binder and about 250° C. for the poly(propylene carbonate) binder.

An important aspect of the present invention is that it is not critical that the printing binder be completely decomposed. Instead, residual carbon left by undecomposed printing binder serves as an electrically conductive material in the cathode active mixture. This means that less conductive diluent needs to be added to the ink to enhance discharge efficiency, as is well known by those skilled in the art. Also, as previously discussed the preferred cathode active mixture binder is a fluoro-polymer material, and preferably, powdered polytetrafluoroethylene. This material begins to decompose at about 230° C., so the final heating temperature must be less than that to prevent loss of functionality for the binder material.

After deposition and combustion of the printing binder, whether it is instantaneous or otherwise, the current collector 18 is ramped down or cooled to ambient temperature, maintained at the heated deposition temperature to enhanced bonding strength, or varied according to a specific profile. In general, it is preferred to conduct the heating steps while contacting the substrate with air or an oxygen-containing gas.

In the case of silver vanadium oxide, it is preferred that the resulting coating have a thickness of from about 1 micron to about 2 millimeters, or more.

While not shown in the drawings, the inked current collector 16 is removed from the conductive block 58 and heated work stage 60 for further processing into an electrical energy storage device, such as an electrochemical cell. A second current collector is then positioned on the conductive block and the cycle is repeated.

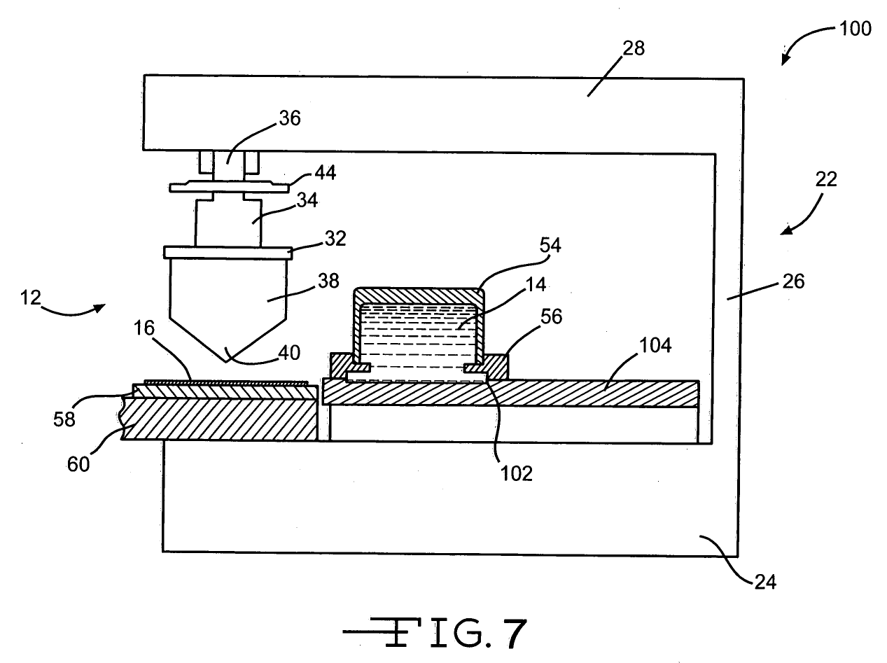

FIGS. 7 to 12 illustrate a second embodiment of a sealed ink cup pad printing apparatus 100 according to the present invention. This apparatus includes many of the same components as the apparatus 10 described with respect to FIGS. 1 to 5, and like parts will be provided with similar numerical designations.

As particularly shown in FIG. 7, the sealed ink cup pad printing apparatus 100 comprises the main frame 22 having the platform 24 fixed to the vertical beam 26 supporting the cantilevered arm 28. In this embodiment, the printing tampon 12 is not only actuatable in an upwardly and downwardly direction, it is also movable in a forwardly and backwardly direction with respect to the cantilevered arm 28. However, in this embodiment instead of the cliché actuating in a back and forth manner, the ink cup 54 does. In that light, FIG. 7 shows the ink cup 54 aligned with the recess 102 of the stationary cliché 104 to deposit a change of the printing ink 14 therein. The printing tampon 12 is in a retracted position aligned vertically above the current collector 16 supported on the conductive block 58 and work stage 60.

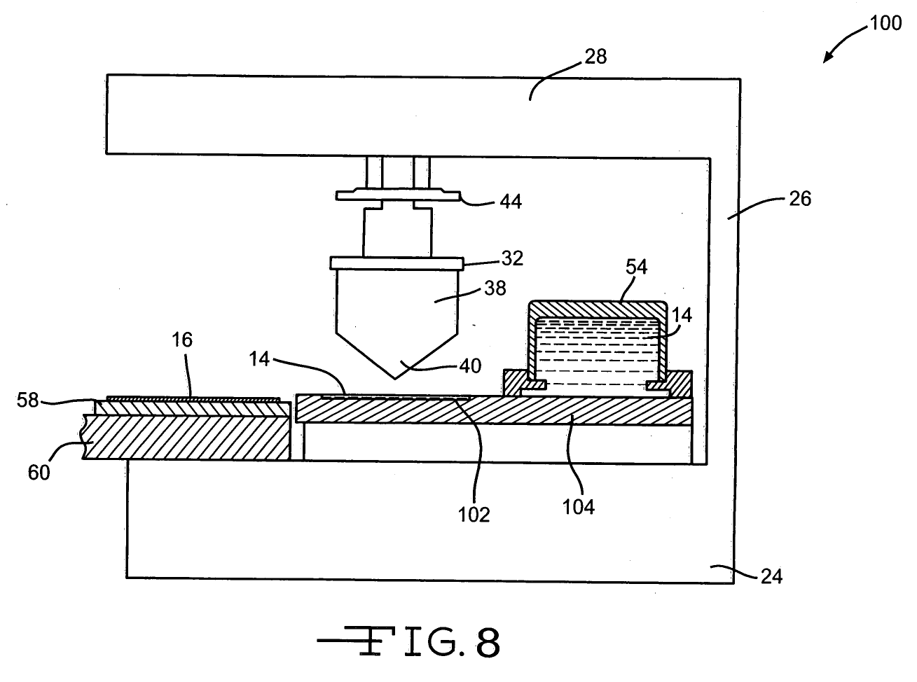

In FIG. 8, the ink cup 54 has retracted along the cliché 104 and away from its recess 102 with a charge of printing ink 14 deposited therein. Likewise, the printing tampon 12 has moved along the cantilevered arm 28 a like distance as the ink cup 54 has moved along the stationary cliché 104. The printing tampon 12 is now positioned vertically above the printing ink 14 deposited in the cliché recess 102.

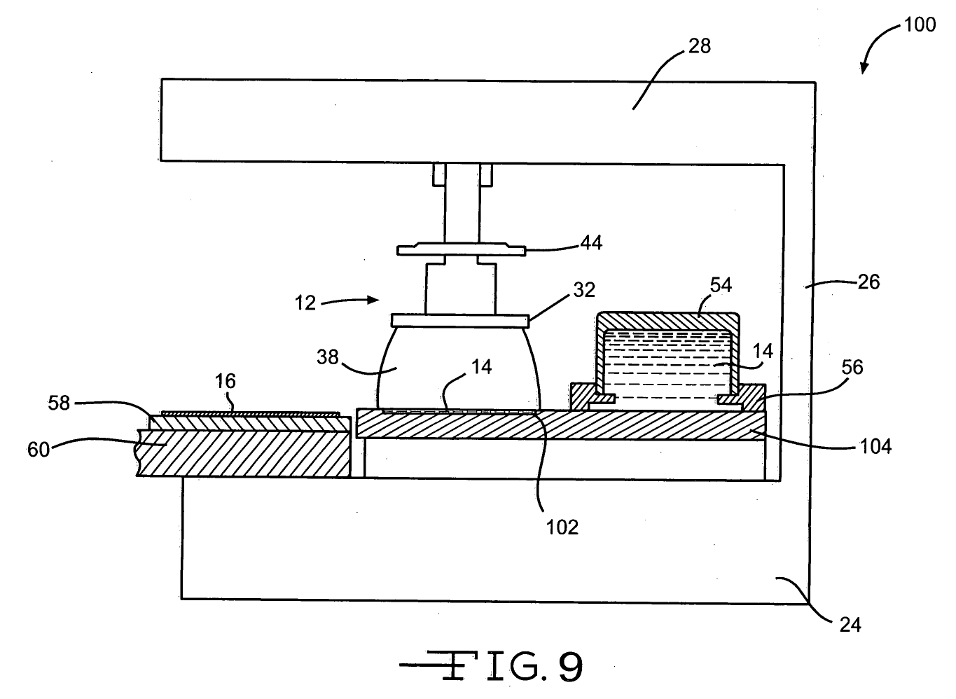

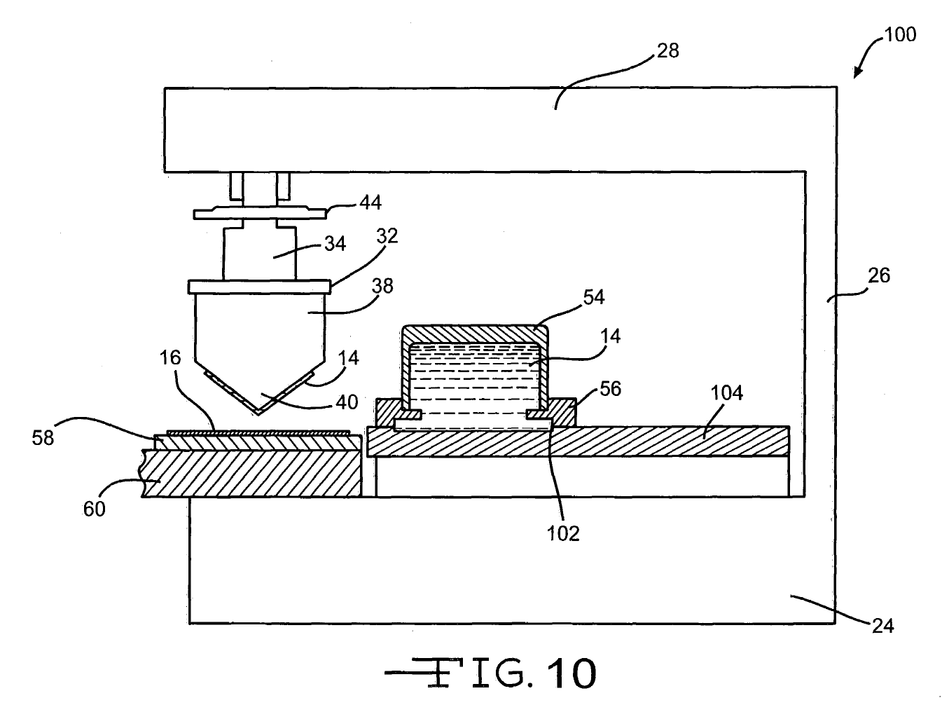

FIG. 9 illustrates the printing tampon 12 having been actuated in a downwardly direction with the pad portion 40 contacting the cliché 104 to pick up the printing ink 14 contained in the recess thereof. The inked printing tampon 12 then retracts into a raised position as the ink cup 54 is simultaneously actuated into alignment with the recess 102 in the cliché 104 to once again deposit a charge of printing ink therein. As in the simultaneous movement described in FIG. 8, the printing tampon 12 and ink cup 54 have each moved a like distance in a reverse direction in FIG. 10. The printing tampon 12 is now vertically aligned with the current collector substrate 16 supported on the conductive block 58 and heated work stage 60.

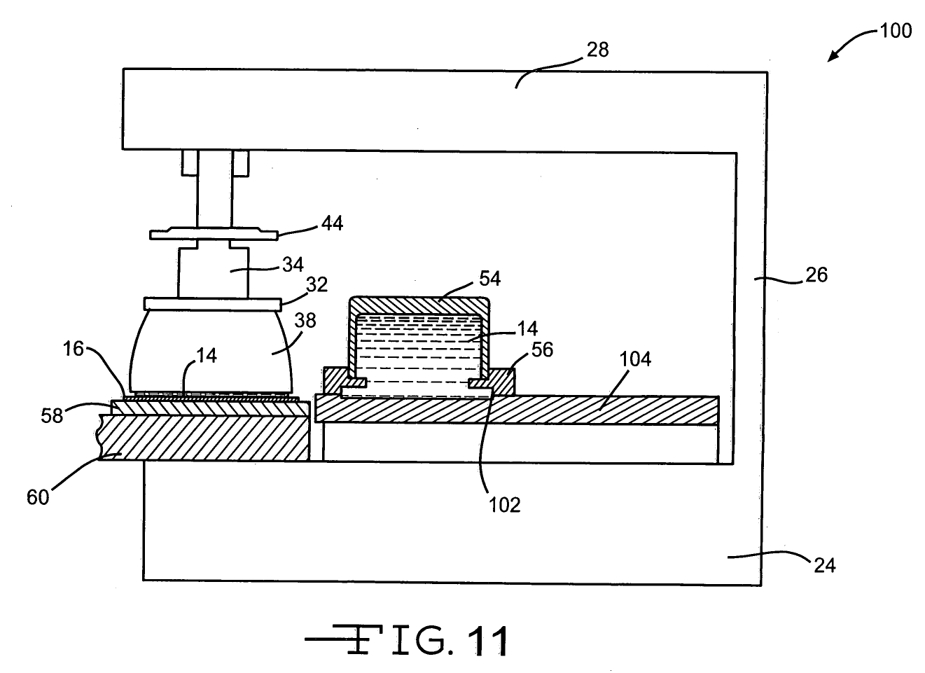

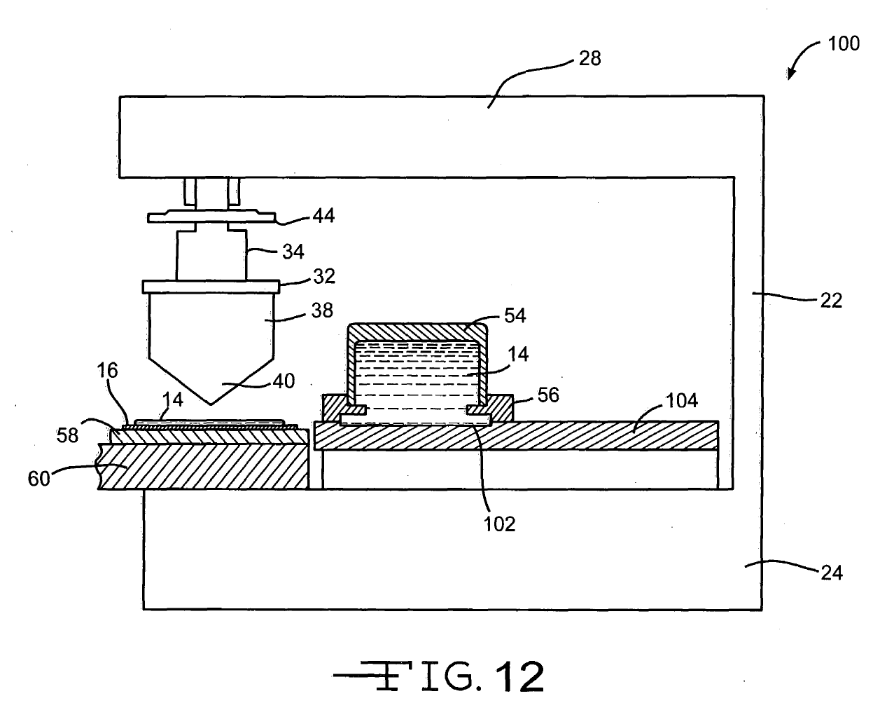

FIG. 11 illustrates the printing tampon 12 having been actuated in a downwardly direction to contact the current collector 16. As this occurs, the pad portion 40 deforms to completely contact the area of the current collector's contact surface 18 to be coated with the printing ink. In that manner, the printing ink 14 is deposited onto the contact surface 18 when the printing tampon 12 moves into the retracted position of FIG. 12. The inked current collector 16 is then removed from the conductive block 58 and heated work stage 60 for further processing into an electrical energy storage device. A second substrate is positioned on the conductive block 58 and the pad printing cycle process is repeated.

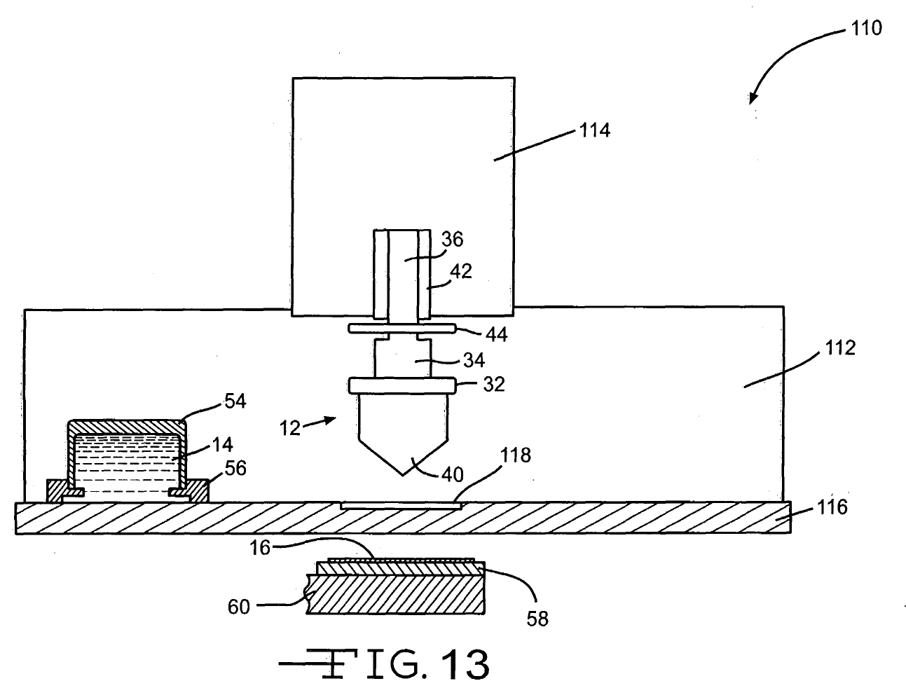

FIGS. 13 to 18 illustrate a third embodiment of a sealed ink cup pad printing apparatus 110 according to the present invention. This apparatus includes many of the same components as the apparatuses 10 and 100 described with respect to FIGS. 1 to 5 and 7 to 12, respectively, and like parts will be provided with similar numerical designations.

As particularly shown in FIG. 13, the pad printing apparatus 110 comprises a main frame 112 supporting a housing 114 for the piston 34 and piston rod 36 actuatable in an upwardly and downwardly direction along a cylinder 42. A limit plate 44 ensures that the piston 34 does not retract upwardly too far to collide with the housing 114. A printing tampon 12 is detachably secured to the end of the piston 36 by a backing plate 32.

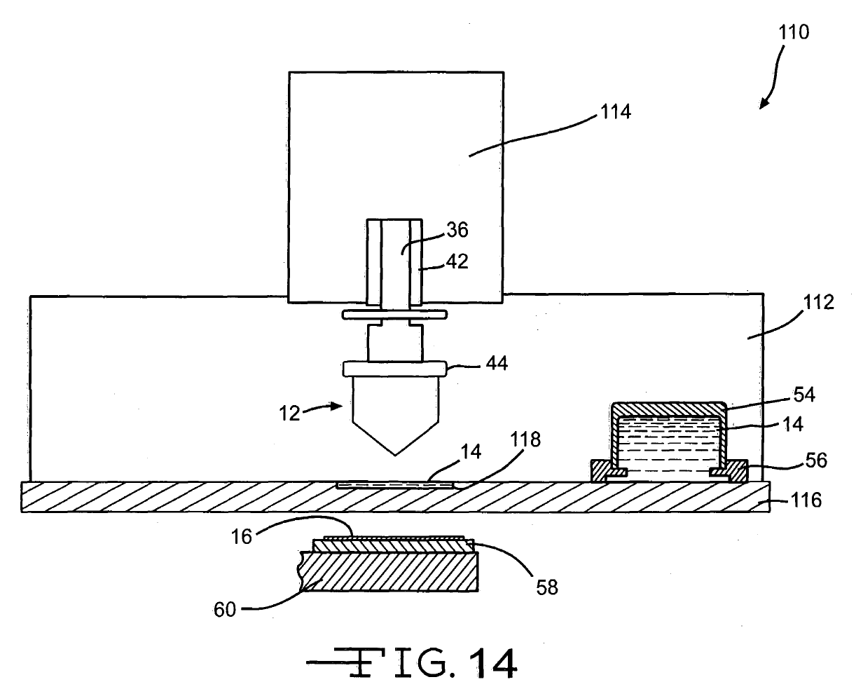

A cliché 116 is connected to the main frame 112 and serves as a stage for backward and forward movement of the ink cup 54 there along. The ink cup 54 is sealed to the cliché 116 by a squeegee ring 56. The cliché 116 includes a recess 118 so that as the ink cup 54 travels back and forth along the cliché 116, the printing ink 14 is precisely filled into the recess 118 (FIG. 14) for subsequent transfer to the printing tampon 12.

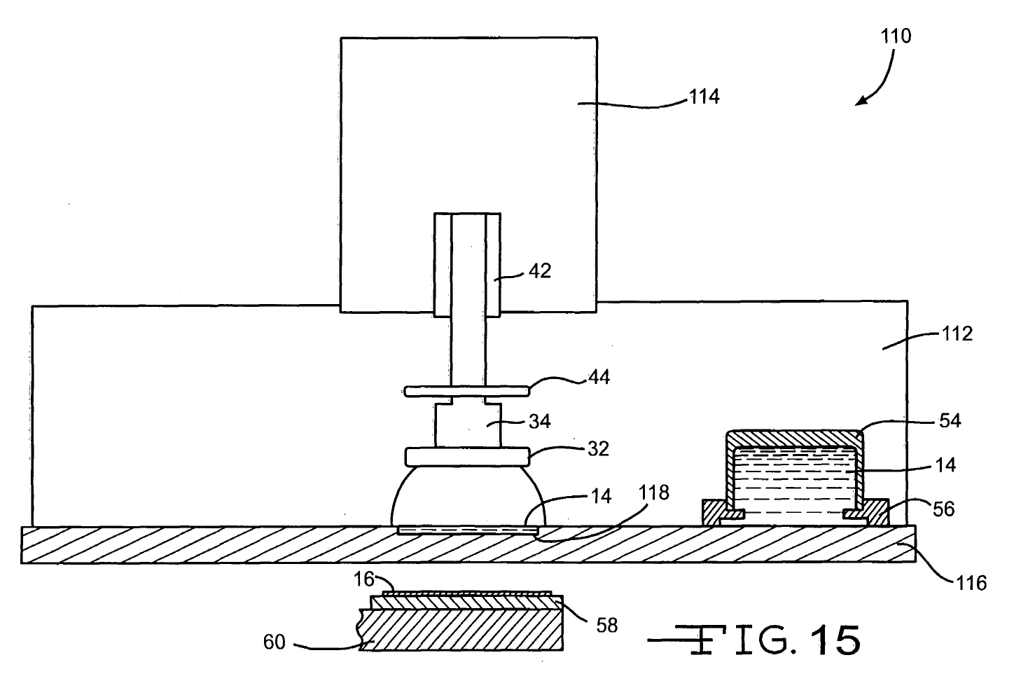

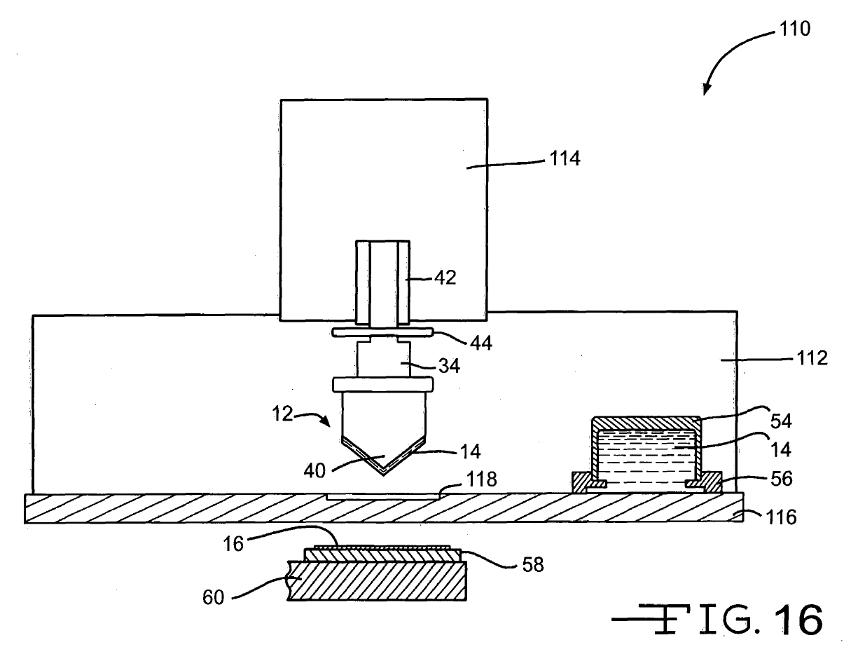

As shown in FIG. 15, once the cliché recess 118 is filled with the printing ink 14 and the ink cup 54 has moved to a position free of the printing tampon 12, the piston 34 is actuated in a downwardly direction. This moves the printing tampon in a downwardly direction to contact the cliché 116 and pick up the printing ink 14 onto its extended pad portion 40. The inked printing tampon 12 then retracts into a raised position. The printing tampon 12 is next actuated in a forwardly direction and into vertical alignment with the current collector 16 supported on the conductive block 58 and heated work stage 60. This positioning is shown in FIG. 16.

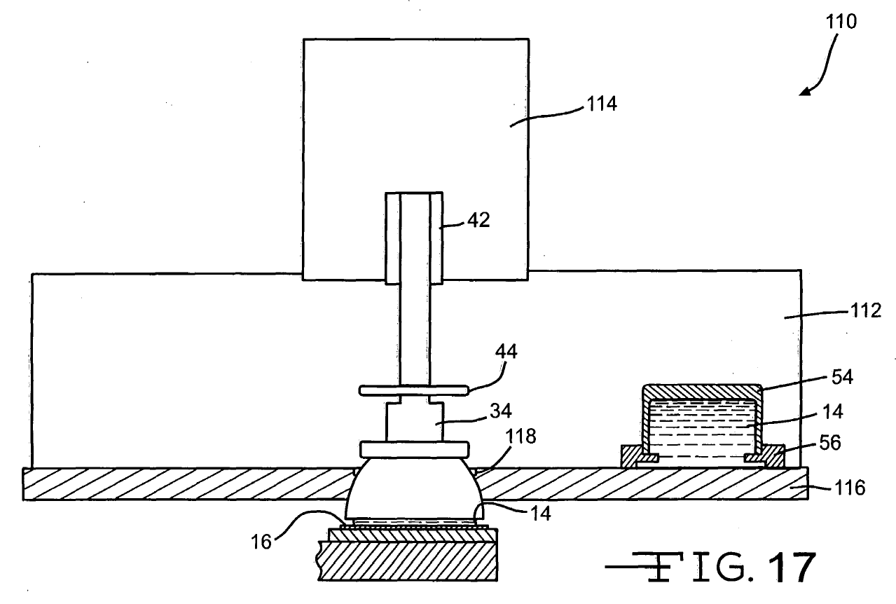

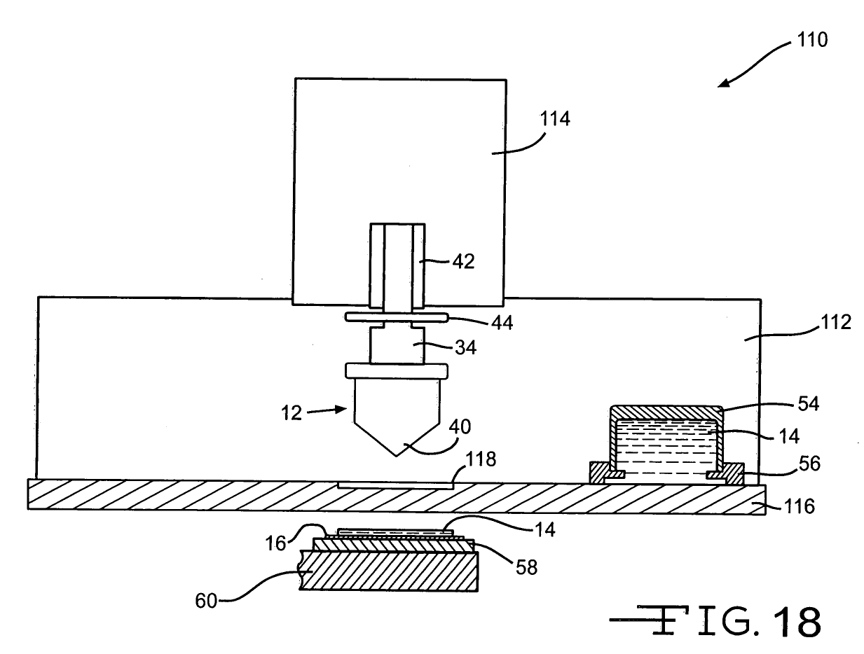

FIG. 17 illustrates the printing tampon 12 having been actuated in a downwardly direction to contact the current collector 16. The pad portion 40 deforms to completely contact the area of the contact surface 18 to be coated with the printing ink. In that manner, the printing ink 14 is deposited onto the current collector's contact surface 18 when the printing tampon 12 moves into the retracted position of FIG. 18. The inked current collector 16 is then removed from the conductive block 58 and heated work stage 60 for further processing into an electrical energy storage device. A second current collector is positioned on the conductive block, and the recess 118 in the cliché 116 is once again precisely filled with the printing ink 14 as the ink cup 54 and seal 56 travel along the cliché 116 to the position shown in FIG. 13. The printing tampon 12 then cycles to pick up the ink and deposit it onto the current collector as previously described.

In that manner, a cycle of the pad printing apparatus 110 is not complete until the ink cup 54 has traveled back and forth across the cliché 116, filling the recess 118 each time. This benefits cycle time as each movement of the ink cup 54 across the cliché 116 results in an inked current collector.

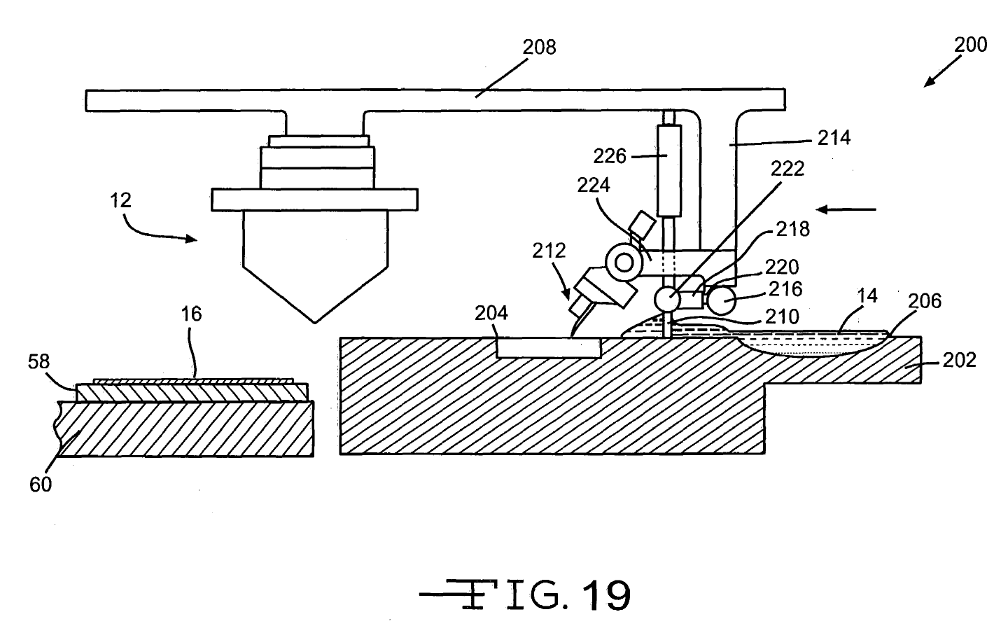

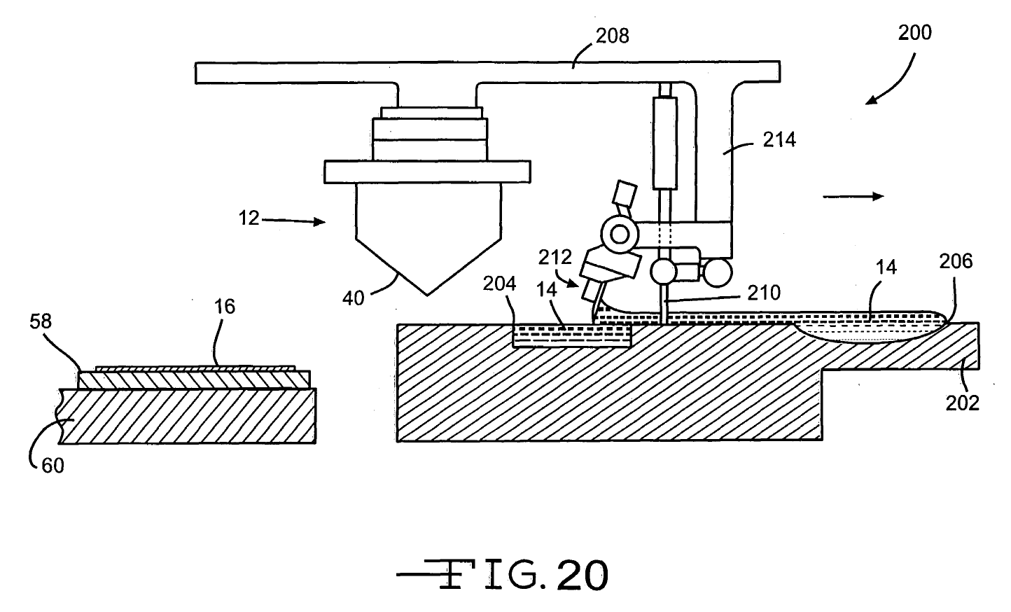

FIGS. 19 to 23 illustrate a further embodiment of the present invention using an open inkwell pad printing apparatus 200 according to the present invention. The open inkwell pad printing apparatus 200 comprises a cliché 202 having a recess 204 and an inkwell 206 containing printing ink 14. Mounted vertically above the cliché 202 is a support beam 208 that provides for vertical translation of the printing tampon 12, a squeegee 210 and a doctor blade 212. The squeegee is connected to the support beam by a depending beam 214 having a first actuatable pivot member 216. A secondary arm 218 is axially movable with respect to a rod 220 connected to the pivot member 216. A second actuatable pivot member 222 is at the distal end of the secondary arm 218 and supports the squeegee 210 for rotational movement into and out of contact with the cliché 202.

A horizontal beam 224 is connected to the depending beam 214 with the doctor blade 212 pivotably supported at the distal end of the horizontal beam 224. An actuatable arm 226 connects between the support beam 208 and the secondary arm 218 for precise pivotable movement of the doctor blade 212 into and out of contact with the cliché 202.

As shown in FIG. 19, a pad printing cycle using the open inkwell printing apparatus 200 begins with a quantity of printing ink 14 filled into the well 206 located in the cliché 202. The squeegee 210 is moved across the inkwell 206 to move a volume of printing ink 14 onto the upper surface of the cliché 202. The printing ink 14 flows into the recess 204 as the squeegee travels to the left. After the recess is filled, the doctor blade 212 is moved back over the recess toward the right to skim any excess printing ink 14 back into the inkwell 206. This provides a precise quantity of printing ink filled into the recess 204.

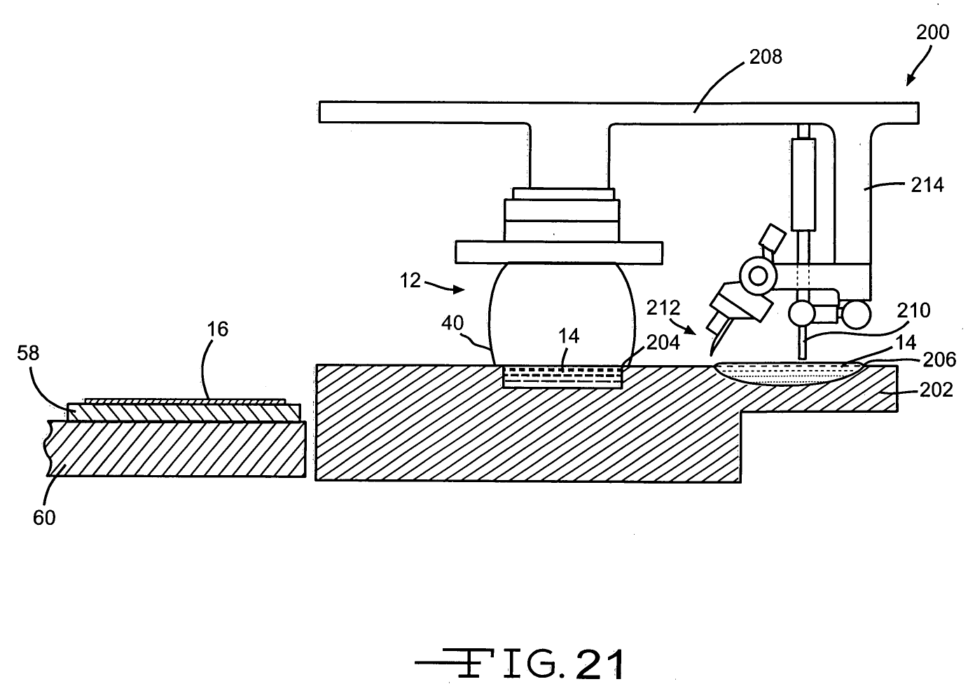

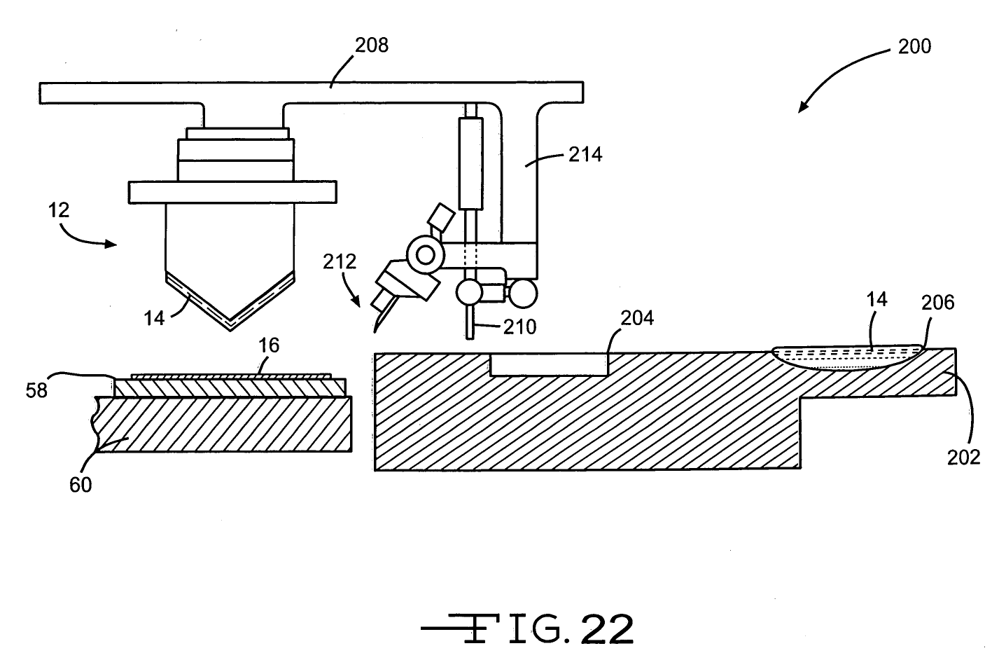

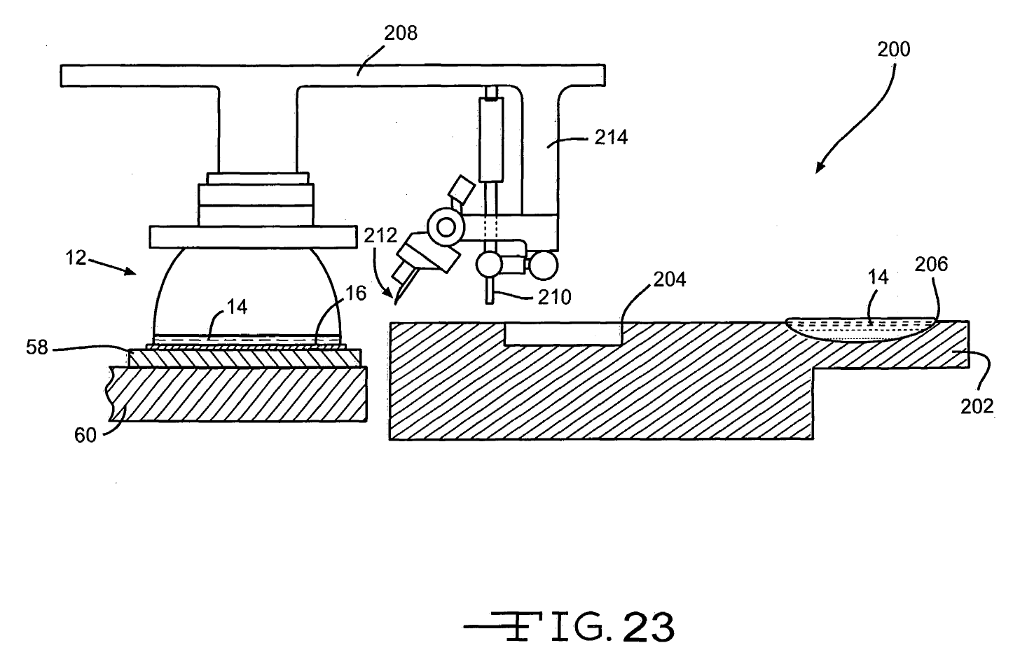

In FIG. 21, the squeegee 210 and doctor blade 212 are pivoted out of contact with the cliché 202. This helps prevent wear. In this drawing, the tampon 12 has also moved in a downwardly direction so that the extended pad portion 40 contacts and picks up the printing ink 14 onto its printing surface. The inked printing tampon 12 is then retraced and moved into a raised position directly above the current collector 16 (FIG. 22). FIG. 23 shows the printing tampon 12 having been actuated in a downwardly direction toward the contact surface 18 of the current collector with its inked pad portion 40. As the pad portion deforms, it completely contacts the area of the current collector 16 to coat the printing ink thereon. As previously described, the conductive block 58 and workstation 60 maintain the current collector at the desired temperature. The inked current collector 16 is then removed from the conductive block 58 and heated work stage 60 for further processing into an electrical energy storage device. A second current collector is positioned on the conductive block and the cycle is repeated.

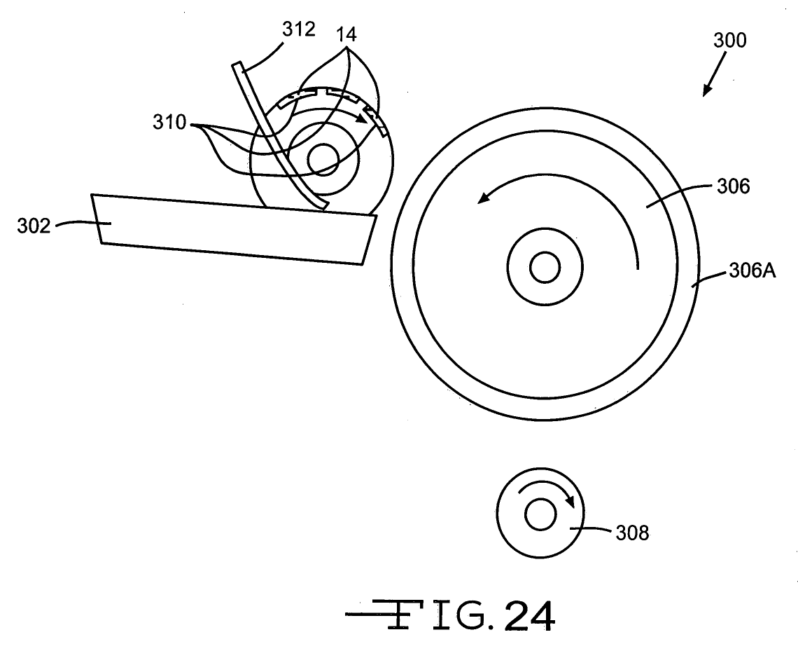

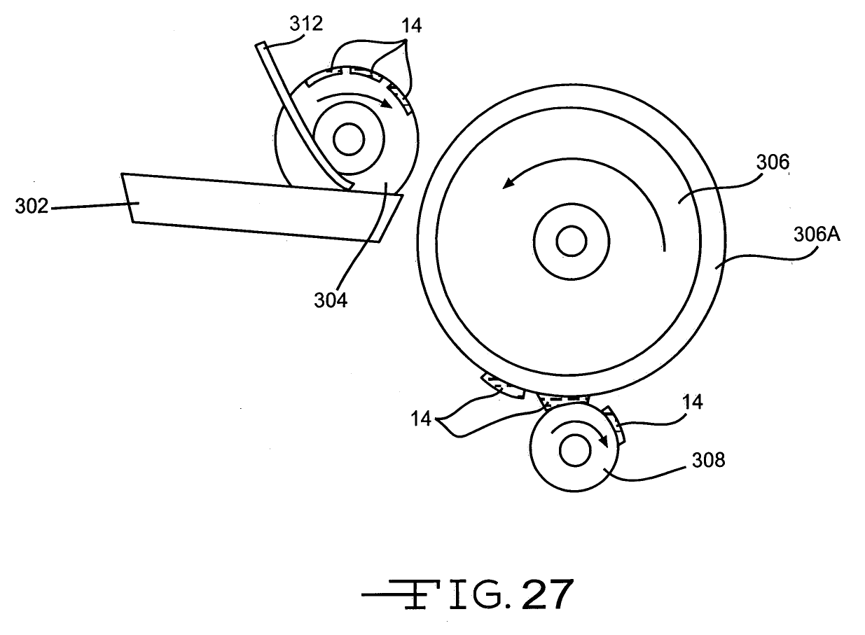

FIGS. 24 to 27 illustrate a further embodiment of a rotary gravure pad printing apparatus 300. This apparatus comprises an inkwell 302 containing printing ink, a cliché in the form of a rotating drum 304, a main roller 306 and a substrate wheel 308. While not shown in the drawings, the wheel 308 supports a plurality of current collectors that will subsequently be processed into electrical energy storage devices according to the present invention.

FIG. 24 shows the cliché drum 304 rotating with its surface immersed in the inkwell 302 to fill the printing ink 14 into recesses 310 spaced along its surface. A squeegee 312 is in the form of a fork having legs supported on the inkwell on opposite sides of the drum 304. An intermediate portion between the legs wipes excess printing ink from the cliché drum 304 so that a precise quantity of printing ink is filled in the recesses 310.

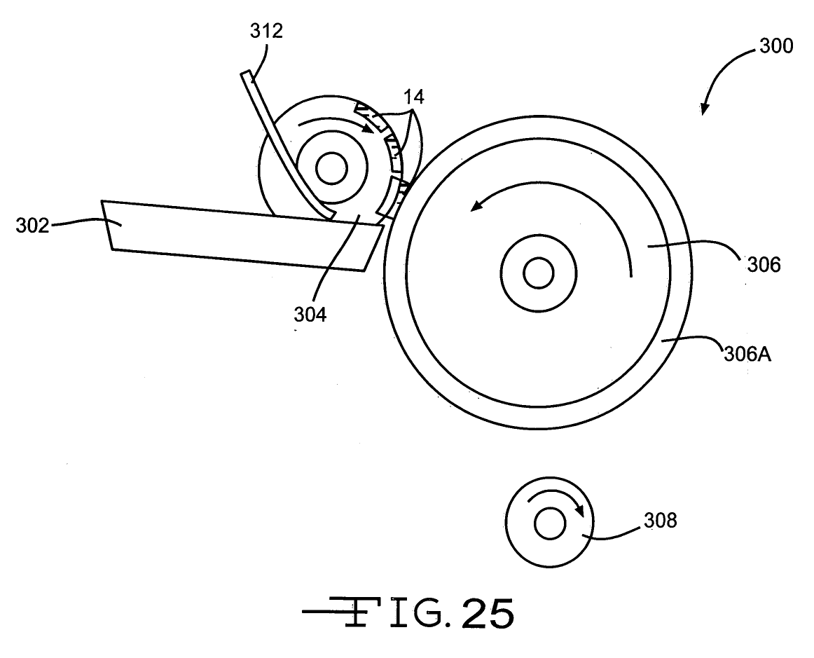

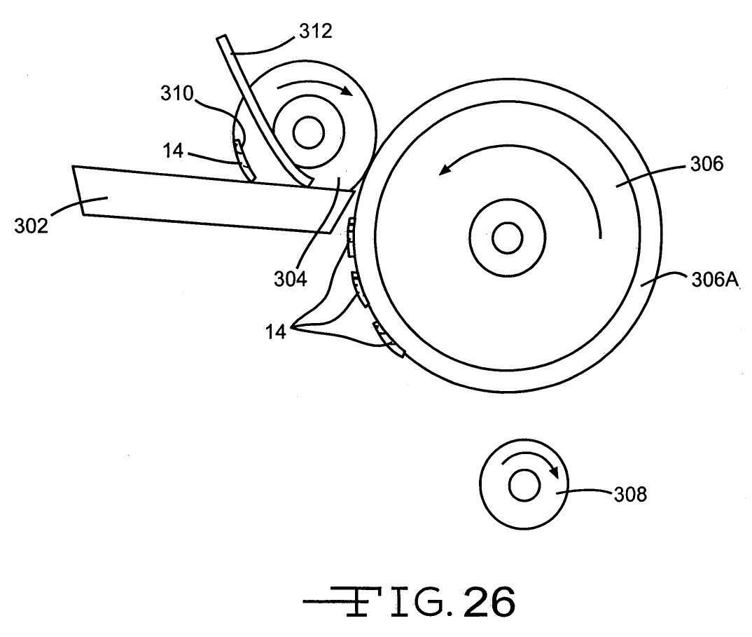

In FIG. 25, the main drum 306 has moved into contact with the cliché drum 304. The main drum 306 is provided with a release contact surface 306A, preferably of silicone, that enables the printing ink 14 to transfer from the cliché thereto, as shown in FIG. 26. The rotating substrate wheel 308 moves into contact with the main drum 306 so that the printing ink 14 is deposited onto current collector substrates (not shown) carried thereon. The current collectors are heat processed as previously described before they are ready for incorporation into an electrochemical cell.

Cathode electrodes prepared by one of the previously described pad printing processes are particularly useful in a novel electrode construction having a relatively high rate capability metal vanadium oxide, for example, SVO, contacted to one side of a current collector while a relatively high energy density material, for example, CFₓ, is contacted to the other side of the current collector. This design has the separate SVO and CFₓ materials short-circuited to each other through the current collector. Providing the active materials in a short circuit relationship means that their respective attributes of high rate and high energy density benefit overall cell discharge performance.

Accordingly, SVO cathode material, which provides a relatively high power or rate capability but a relatively low energy density or volumetric capability and CFₓ cathode material, which has a relatively high energy density but a relatively low rate capability, are individually contacted to current collector screens, preferably by one of the previously described pad printing processes. This provides both materials in direct contact with the current collector. Therefore, one exemplary cathode plate for a primary cell has the following configurations:

### SVO/current collector/CFₓor SVO/current collector/CFₓ/current collector/SVO.

An important aspect of the present invention is that the high rate cathode material (in this case the SVO material) maintains direct contact with the current collector. Another embodiment of the present invention has the high capacity/low rate material sandwiched between the high rate cathode materials, in which the low rate/high capacity material is in direct contact with the high rate material. This cathode design has the following configuration:

SVO/current collector/SVO/CFₓ/SVO/current collector/SVO

Another important aspect of the present invention is that the high capacity material having the low rate capability is preferably positioned between two layers of high rate cathode material (either high or low capacities). In other words, the exemplary CFₓ material never directly faces the lithium anode. In addition, the low rate cathode material must be short circuited with the high rate material, either by direct contact as demonstrated above in the second embodiment, or by parallel connection through the current collectors as in the first illustrated embodiment above. This electrode construction is described in U.S. Pat. No. 6,551,747 to Gan, which is assigned to the assignee of the present invention and incorporated herein by reference.

In a preferred construction method, CFₓ is first contacted to one side of the current collector by any suitable means including one of the present pad printing techniques. A barrier is provided on the opposite side of the current collector to prevent CFₓ from moving through the current collector openings to the other side thereof. Then, the SVO material is contacted to the opposite side of the current collector by one of the pad printing processes.

As particularly shown in FIG. 6A, providing the high rate capability material 14A, for example SVO, in the printing ink means that the active material particles can move through the current collector openings to completely contact the high energy density material, for example CFₓ, in a robust short circuit locking relationship. In that manner, when both materials are laid down as a printing ink, they completely cover the open area between the current collector strands 16A to contact and coat the sidewalls of the strands for maximum locking relationship between them. For a more thorough discussion regarding contacting two different active materials to opposite sides of a current collector, reference is made to U.S. Pat. Nos. 6,727,022 and 6,743,547, both to Gan et al. These patents are assigned to the assignee of the present invention and incorporated herein by reference.

This is in contrast to contacting the active materials, whether they are the same or different, to the opposite sides of the current collector in a conventional manner. This can be as a pressed powder mixture as described in U.S. Pat. Nos. 4,830,940 and 4,964,877 to Keister et al. or as a freestanding sheet as described in U.S. Pat. Nos. 5,435,874 and 5,571,640 to Takeuschi et al., or by other well known techniques. These patents are assigned to the assignee of the present invention and incorporated herein by reference.

A conventional electrode construction is shown in FIG. 6B, where even though the first and second active materials 14A and 14B contact each other through the current collector openings, they do not completely contact the sidewalls of the current collector strands 16A. This means the locking relationship in a conventionally built electrode is not as robust, and the probability of sloughing, delamination, and the like, of the active materials from the current collector is greater than in an electrode built having at least one of the current collector sides coated with a printing ink according to the present invention.

In addition to silver vanadium oxide, copper silver vanadium oxide, V₂O₅, MnO₂, LiCoO₂, LiNiO₂, LiMn₂O₄, TiS₂, Cu₂S, FeS, FeS₂, copper oxide, copper vanadium oxide, and mixtures thereof are useful as the first active material. And, in addition to fluorinated carbon, Ag₂O, Ag₂O₂, CuF, Ag₂CrO₄, MnO₂, and even SVO itself, are useful as the second active material. The theoretical volumetric capacity (Ah/ml) of CFₓ is 2.42, Ag₂O₂ is 3.24, Ag₂O is 1.65 and AgV₂O_{5.5} is 1.37. Thus, CFₓ, Ag₂O₂, Ag₂O, all have higher theoretical volumetric capacities than that of SVO.

As previously discussed, before fabrication into an electrode structure, the first and second cathode active materials are preferably mixed with a binder material such as a powdered fluoro-polymer at about 1 to about 5 weight percent of the cathode mixture and up to about 10 weight percent of a conductive diluent. The preferred first cathode active mixture thus includes a powdered fluoro-polymer electrode binder present at about 3 weight percent, a conductive diluent present at about 3 weight percent and about 94 weight percent of the metal vanadium oxide active material. A preferred second active mixture is, by weight, 91% CFₓ, 4% PTFE and 5% carbon black.

The thusly produced cathode electrodes, preferably containing silver vanadium oxide contacted to one side of the current collector and CFₓ contacted to the other side are incorporated into primary electrochemical cells that possess sufficient energy density and discharge capacity required to meet the rigorous requirements of implantable medical devices, such as cardiac defibrillators. In that manner, the cathode is coupled to an anode of a metal selected from Groups IA, IIA and IIIB of the Periodic Table of the Elements. Such anode active materials include lithium, sodium, potassium, etc., and their alloys and intermetallic compounds including, for example, Li—Si, Li—Al, Li—B and Li—Si—B alloys and intermetallic compounds. The preferred anode comprises lithium. An alternate anode comprises a lithium alloy such as a lithium-aluminum alloy. The greater the amounts of aluminum present by weight in the alloy, however, the lower the energy density of the cell.

The form of the anode may vary, but preferably it comprises a thin metal sheet or foil of the anode metal, pressed or rolled on a metallic anode current collector of titanium, titanium alloy, nickel, copper, tungsten or tantalum. The anode has an extended tab that is subsequently welded to a cell case of conductive metal in a case-negative electrical configuration. Alternatively, the anode may be formed in some other geometry, such as a bobbin shape, cylinder or pellet to allow an alternate low surface cell design.

A separator structure of electrically insulative material is provided between the anode and the cathode to prevent an internal electrical short circuit between the electrodes. The separator material also is chemically unreactive with the anode and cathode active materials and both chemically unreactive with and insoluble in the electrolyte. In addition, the separator material has a degree of porosity sufficient to allow flow therethrough of the electrolyte during the electrochemical reaction of the capacitor. Illustrative separator materials include woven and non-woven fabrics of polyolefinic fibers including polypropylene and polyethylene or fluoropolymeric fibers including polyvinylidene fluoride, polyethylenetetrafluoroethylene, and polyethylenechlorotrifluoroethylene laminated or superposed with a polyolefinic or fluoropolymeric microporous film, non-woven glass, glass fiber materials and ceramic materials. Suitable microporous films include a polyethylene membrane commercially available under the designation SOLUPOR (DMS Solutech), a polytetrafluoroethylene membrane commercially available under the designation ZITEX (Chemplast Inc.), a polypropylene membrane commercially available under the designation CELGARD (Celanese Plastic Company, Inc.) and a membrane commercially available under the designation DEXIGLAS (C. H. Dexter, Div., Dexter Corp.).

A secondary cell according to the present invention takes advantage of active materials that are typically used as cathode active materials in primary cells, but which cannot normally be used in conventional secondary cells. The current art in rechargeable cells is to use the positive electrode as the source of alkali metal ions. This prohibits the use of metal-containing active materials that do not contain alkali metal ions. Examples of such metal-containing materials include V₂O₅, V₆O₁₃, silver vanadium oxide (SVO), copper silver vanadium oxide (CSVO), MnO₂, TiS₂, MOS₂, NbSe₃, CuO₂, Cu₂S, FeS, FeS₂, CFₓ, Ag₂O, Ag₂O₂, CuF, Ag₂CrO₄, copper oxide, copper vanadium oxide, and mixtures thereof.

However, the positive electrode of the present secondary cells is built in a double current collector configuration having a “sacrificial” piece of alkali metal, preferably lithium, sandwiched between the current collectors. A pad printed cathode active material capable of intercalation and de-intercalation the alkali metal contacts the opposite side of at least one, and preferably both, of the current collectors. The purpose of the sacrificial alkali metal is to react with the cathode active material upon the cell being activated with an electrolyte. The reaction results in a lithiated cathode active material.

Suitable current collectors are selected from copper, stainless steel, titanium, tantalum, platinum, gold, aluminum, nickel, cobalt nickel alloy, highly alloyed ferritic stainless steel containing molybdenum and chromium, and nickel-, chromium-, and molybdenum-containing alloys. Preferably the current collector is a perforated foil or screen, such as an expanded screen.

Preferred embodiments for a secondary cell include the following positive electrode configurations:

vanadium oxide/current collector/lithium/current collector/vanadium oxide, or

vanadium oxide/current collector/vanadium oxide/lithium/vanadium oxide/current collector/vanadium oxide, or

vanadium oxide/current collector/lithium, with the vanadium oxide facing the negative electrode.

By the term “vanadium oxide” is meant V₂O₅, V₆O₁₃, silver vanadium oxide, and copper silver vanadium oxide in a nanoparticle form.

With this double current collector electrode design, the amount of lithium metal is adjusted to fully lithiate the cathode active material. Upon activating the cell with an ion-conductive electrolyte, the alkali metal migrates into the cathode active material resulting in complete consumption of the alkali metal. The absence of the alkali metal in the cell preserves the desirable safety and cycling properties of the intercalation negative and positive electrodes.

The anode or negative electrode for the secondary cell comprises an anode material capable of intercalating and de-intercalating lithium. Typically, the anode material of the negative electrode comprises any of the various forms of carbon (e.g., coke, graphite, acetylene black, carbon black, glassy carbon, etc.) that are capable of reversibly retaining the lithium species. Graphite is particularly preferred in conventional secondary cells. “Hairy carbon” is another particularly preferred conventional material due to its relatively high lithium-retention capacity. “Hairy carbon” is a material described in U.S. Pat. No. 5,443,928 to Takeuchi et al., which is assigned to the assignee of the present invention and incorporated herein by reference.

The negative electrode for a secondary cell is fabricated by mixing about 90 to 97 weight percent of the carbonaceous anode material with about 3 to 10 weight percent of an electrode binder material, which is preferably a fluoro-resin powder such as polytetrafluoroethylene (PTFE), polyvinylidene fluoride (PVDF), polyethylenetetrafluoroethylene (ETFE), polyamides, polyimides, and mixtures thereof. This negative electrode admixture is provided on a current collector selected from copper, stainless steel, titanium, tantalum, platinum, gold, aluminum, nickel, cobalt nickel alloy, highly alloyed ferritic stainless steel containing molybdenum and chromium, and nickel-, chromium-, and molybdenum-containing alloys. The current collector is a foil or screen and contact is by casting, pressing, or rolling the admixture thereto.

Another type of pad printable anode material useful with the present invention is a metal that reversibly alloys with alkali metals. Such metals include, but are not limited to, Sn, Si, Al, Pb, Zn, Ag, SnO, SnO₂, SiO, and SnO(B₂O₃)ₓ(P₂O₅)_{y}. For a more detailed description of the use of these materials in the negative electrode of a secondary cell, reference is made to U.S. application Ser. No. 10/008,977, filed Nov. 8, 2001, which is assigned to the assignee of the present invention and incorporated herein by reference.

The primary electrochemical cell further includes a nonaqueous electrolyte that exhibits those physical properties necessary for ionic transport, namely, low viscosity, low surface tension and wettability. The electrolyte has an inorganic, ionically conductive salt dissolved in a mixture of aprotic organic solvents comprising a low viscosity solvent and a high permittivity solvent. In the case of an anode comprising lithium, preferred lithium salts that are useful as a vehicle for transport of lithium ions from the anode to the cathode include LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, Li₂CCF₃, LiSO₆F, LiB(C₆H₅)₄ and LiCF₃SO₃, and mixtures thereof.

Low viscosity solvents useful with the present invention include esters, linear and cyclic ethers and dialkyl carbonates such as tetrahydrofuran, methyl acetate, diglyme, trigylme, tetragylme, dimethyl carbonate (DMC), 1,2-dimethoxyethane (DME), 1,2-diethoxyethane, 1-ethoxy, 2-methoxyethane, ethyl methyl carbonate, methyl propyl carbonate, ethyl propyl carbonate, diethyl carbonate, dipropyl carbonate, and mixtures thereof, and high permittivity solvents include cyclic carbonates, cyclic esters and cyclic amides such as propylene carbonate (PC), ethylene carbonate (EC), butylene carbonate, acetonitrile, dimethyl sulfoxide, dimethyl formamide, dimethyl acetamide, γ-valerolactone, γ-butyrolactone, N-methyl-pyrrolidone, and mixtures thereof. In a primary cell, the preferred anode is lithium metal and the preferred electrolyte is 0.8M to 1.5M LiAsF₆ or LiPF₆ dissolved in a 50:50 mixture, by volume, of propylene carbonate and 1,2-dimethoxyethane.

A preferred electrolyte for a secondary cell comprises a solvent mixture of EC:DMC:EMC:DEC. Most preferred volume percent ranges for the various carbonate solvents include EC in the range of about 20% to about 50%; DMC in the range of about 12% to about 75%; EMC in the range of about 5% to about 45%; and DEC in the range of about 3% to about 45%. In a preferred form, the electrolyte is at equilibrium with respect to the molar ratio of DMC:EMC:DEC. This electrolyte is described in detail in U.S. Pat. No. 6,746,804 to Gan et al., which is assigned to the assignee of the present invention and incorporated herein by reference.

The above described primary and secondary cells are in the form of one or more cathode plates operatively associated with one or more anode plates. Alternatively, the negative and positive electrodes, both in strip form, are provided with an intermediate separator and wound together in a “jellyroll” type configuration or “wound element cell stack” such that the negative electrode is on the outside of the roll to make electrical contact with the caseing in a case-negative configuration. Using suitable top and bottom insulators, the wound cell stack is inserted into a metallic case of a suitable size dimension. The metallic case may comprise materials such as stainless steel, mild steel, nickel-plated mild steel, titanium, tantalum or aluminum, but not limited thereto, so long as the metallic material is compatible for use with the other cell components.

The cell header comprises a metallic disc-shaped body with a first hole to accommodate a glass-to-metal seal/terminal pin feedthrough and a second hole for electrolyte filling. The glass used is of a corrosion resistant type having up to about 50% by weight silicon such as CABAL 12, TA 23, FUSITE 425 or FUSITE 435. The positive terminal pin feedthrough preferably comprises titanium although molybdenum, aluminum, nickel alloy, or stainless steel can also be used. The cell header is typically of a material similar to that of the case. The positive terminal pin supported in the glass-to-metal seal is, in turn, supported by the header, which is welded to the casing. The cell is thereafter filled with the electrolyte solution described hereinabove and hermetically sealed such as by close-welding a stainless steel ball over the fill hole, but not limited thereto.

While a case-negative design is preferred, it is well known to those skilled in the art that the present electrochemical systems can also be constructed in case-positive configurations.

It is appreciated that various modifications to the inventive concepts described herein may be apparent to those of ordinary skill in the art without departing from the scope of the present invention as defined by the appended claims.

1. (canceled)

2. The printing ink of claim 13 wherein the solvent is selected from the group consisting of cyclohexanone, n-octyl alcohol, ethylene glycol, water, and mixtures thereof.

3.-12. (canceled)

13. A printing ink contactable to a substrate for forming an electrode for an electrical energy storage device, the printing ink comprising:
a) an active material mixture, which comprises:
i) active material selected from the group consisting of silver vanadium oxide, copper silver vanadium oxide, fluorinated carbon, copper oxide, copper vanadium oxide, V₂O₅, V₆O₁₃, MnO₂, LiCoO₂, LiNiO₂, LiMn₂O₄, TiS₂, Cu₂S, FeS, FeS₂, Ag₂O, Ag₂O₂, CuF, Ag₂CrO₄, MoS₂, NbSe₃, and mixtures thereof; and
ii) a fluoro-polymer electrode binder;
b) a solvent; and
c) a printing binder of poly(alkylene carbonate) having the general formula R—O—C(═O)—O with R═C1 to C5.

14. (canceled)

15. The printing ink of claim 13 contactable to a substrate current collector to provide at least a portion of a cathode of the configuration: SVO/current collector CFₓ, SVO/current collector/CFₓ/current collector/SVO, or SVO/current collector/SVO/CFₓ/SVO/current collector/SVO.

16.-21. (canceled)

22. The printing ink of claim 15 wherein the substrate is selected from the group consisting of titanium, molybdenum, tantalum, niobium, cobalt, nickel, stainless steel, tungsten, platinum, palladium, gold, silver, copper, chromium, vanadium, aluminum, zirconium, hafnium, zinc, iron, and alloys thereof.

23. The printing ink of claim 13 further comprising a conductive diluent.

24. The printing ink of claim 13 wherein the fluoro-polymer electrode binder is selected from the group consisting of powdered polytetrafluoroethylene, powdered polyvinylidene fluoride, and mixtures thereof.

25. The printing ink of claim 13 wherein the fluoro-polymer electrode binder is present at about 1 to about 5 weight percent thereof.

26. The printing ink of claim 23 wherein the conductive diluent is selected from the group consisting of acetylene black, carbon black, graphite, powdered nickel, powdered aluminum, powdered titanium, powdered stainless steel, and mixtures thereof.

27. The printing ink of claim 23 wherein the conductive diluent is present up to about 10 weight percent of the active material mixture.

28. The printing ink of claim 13 wherein the active material mixture comprises about 3 weight percent of the fluoro-polymer binder, about 3 weight percent of a conductive diluent, about 94 weight percent of the active material, remainder being the solvent and printing binder.

29. A printing ink contactable to a substrate for forming an electrode for an electrical energy storage device, the printing ink comprising:
a) an active material mixture, which comprises:
i) silver vanadium oxide; and
ii) a fluoro-polymer electrode binder;
b) a solvent; and
c) a printing binder of poly(alkylene carbonate) having the general formula R—O—C(═O)—O with R═C1 to C5.

30. The printing ink of claim 29 wherein the solvent is selected from the group consisting of cyclohexanone, n-octyl alcohol, ethylene glycol, water, and mixtures thereof.

31. The printing ink of claim 29 wherein the fluoro-polymer electrode binder is selected from the group consisting of powdered polytetrafluoroethylene, powdered polyvinylidene fluoride, and mixtures thereof.

32. The printing ink of claim 29 further comprising a conductive diluent selected from the group consisting of acetylene black, carbon black, graphite, powdered nickel, powdered aluminum, powdered titanium, powdered stainless steel, and mixtures thereof.

33. The printing ink of claim 29 wherein the silver vanadium oxide has an average particle size of less than about 500 μm.

34. The printing ink of claim 29 wherein the silver vanadium oxide has an average diameter of from about 0.5 μm to about 200 μm.

35. The printing ink of claim 29 contactable to a substrate current collector to provide a cathode of the configuration: SVO/current collector CFₓ, SVO/current collector/CFₓ/current collector/SVO, or SVO/current collector/SVO/CFₓ/SVO/current collector/SVO.

36. The printing ink of claim 35 wherein the substrate is selected from the group consisting of titanium, molybdenum, tantalum, niobium, cobalt, nickel, stainless steel, tungsten, platinum, palladium, gold, silver, copper, chromium, vanadium, aluminum, zirconium, hafnium, zinc, iron, and alloys thereof.
